(19) United States
(12) Patent Application Publication
(10) Pub. No.: US 2023/0011209 A1
(43) Pub. Date: Jan. 12, 2023

(54) SYSTEMS AND METHODS FOR PREDICTING USER TRAVEL

(71) Applicant: Capital One Services, LLC, McLean, VA (US)

(72) Inventors: Allison Fenichel, Brooklyn, NY (US); Jacob Balgoyen, Arlington, VA (US); Daniel Marsch, Sterling, VA (US); Lin Ni Lisa Cheng, New York, NY (US); Viraj Chaudhary, Katy, TX (US); Isaac Yi, Arlington, VA (US)

(21) Appl. No.: 17/370,935

(22) Filed: Jul. 8, 2021

(51) Int. Cl. G06Q 20/40; G06Q 20/38; G06N 20/00

(52) U.S. Cl. CPC G06Q 20/4016; G06Q 20/4015; G06Q 20/382; G06N 20/00

(57) ABSTRACT

A system may include one or more processors, a memory in communication with the one or more processors, and storing instructions, that when executed by the one or more processors, are configured to cause the system to predict user travel. The system may receive transaction data, and extract travel information from the transaction data. The system may assign a confidence score to the travel information based on comparing the travel information to previous travel information. The system may determine whether the confidence score is greater than or equal to one or more thresholds. Responsive to determining the confidence score is greater than or equal to one or more thresholds, the system may perform one or more fraud prevention activities.

### FIELD

The disclosed technology relates to systems and methods for predicting user travel, and more particularly for performing one or more fraud prevention activities related to the use of an account based on a likelihood the account is being used for travel.

### BACKGROUND

Traditional systems and methods require users to contact their respective financial institutions when the users plan to use an account (e.g., a credit card account) when traveling. This action is necessary to ensure financial institutions do not limit or close certain accounts when they recognize those accounts being used in geographic regions outside of users' typical geographic regions. If users fail to take this action, sometimes well ahead of a planned trip, financial institutions may perform actions that can be particularly inconvenient to users especially when traveling, such as locking an account. Users may then end up without an account and/or having to deal with contacting the responsible financial institution while traveling.

Accordingly, there is a need for improved systems and methods that allow for automatic prediction of travel such that a system may perform one or more fraud prevention activities surrounding the use of an account based on the likelihood the account is being used for travel. Embodiments of the present disclosure are directed to this and other considerations.

### SUMMARY

Disclosed embodiments provide systems and methods for predicting user travel that enable a system to perform one or more fraud prevention activities related to the use of an account based on the travel prediction.

Consistent with the disclosed embodiments, a system may include one or more processors and a memory in communication with the one or more processors and storing instructions, that when executed by the one or more processors, are configured to cause the system to perform a method for predicting user travel. For example, the system may receive transaction data. The system may then extract travel information (related to, e.g., location, merchant, entity, time, date, price, etc.) from the transaction data. The system may assign a confidence score to the travel information based on comparing the travel information to previous travel information. The system may determine whether the confidence score is greater than or equal to a first threshold. The system may also determine whether the confidence score is greater than or equal to a second threshold. Responsive to determining the confidence score is greater than or equal to the first threshold and the second threshold, the system may perform a first fraud prevention activity (e.g., flagging an account as being used for travel). Responsive to determining the confidence score is not greater than or equal to the first threshold but is greater than or equal to the second threshold, the system may perform a second fraud prevention activity (e.g., reducing a credit limit of an account). Responsive to determining the confidence score is not greater than or equal to the first threshold or the second threshold, the system may perform a third fraud prevention activity (e.g., locking an account).

In another embodiment, a system may include one or more processors and a memory in communication with the one or more processors and storing instructions, that when executed by the one or more processors, are configured to cause the system to perform a method for predicting user travel. For example, the system may receive transaction data. The system may then extract travel information from the transaction data. The system may assign a confidence score to the travel information based on comparing the travel information to previous travel information. The system may determine whether the confidence score is greater than or equal to a first threshold. The system may also determine whether the confidence score is greater than or equal to a second threshold. Responsive to determining the confidence score is greater than or equal to the first threshold and the second threshold, the system may flag an account associated with the travel information as being used for travel. Responsive to determining the confidence score is not greater than or equal to the first threshold but is greater than or equal to the second threshold, the system may transmit a message to a user of the account to identify whether the account is being used for travel.

In another embodiment, a system may include one or more processors and a memory in communication with the one or more processors and storing instructions, that when executed by the one or more processors, are configured to cause the system to perform a method for predicting user travel. For example, the system may receive transaction data. The system may then extract travel information from the transaction data. The system may assign a confidence score to the travel information based on comparing the travel information to previous travel information. The system may determine whether the confidence score is greater than or equal to a first threshold. Responsive to determining the confidence score is greater than or equal to the first threshold, the system may identify one or more activities compatible with the travel information, i.e., one or more events associated with a date, time, and/or a location of the travel information. The system may also provide, to a user associated with the travel information, one or more recommendations (e.g., a flight, hotel, restaurant, recreational activity, conference, etc.) corresponding to the one or more activities.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a block diagram of an example system environment that may be used to implement one or more embodiments of the present disclosure;

FIG. 2 is a component diagram of a fraud prevention system in accordance with one or more embodiments of the present disclosure;

FIG. 3 is a flowchart of a method for predicting user travel, in accordance with one or more embodiments of the present disclosure;

FIG. 4 is a flowchart of a method for predicting user travel, in accordance with one or more embodiments of the present disclosure; and

FIG. 5 is a flowchart of a method for predicting user travel, in accordance with one or more embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

By way of introduction, aspects discussed herein may relate to systems and methods for predicting user travel. For example, some embodiments describe determining whether an assigned confidence score is greater than or equal to one or more thresholds, and in response to determining the confidence score is greater than or equal to one or more thresholds, performing one or more fraud prevention activities. These provide advantages over other systems and methods by eliminating the need to alert financial institutions when users might be using certain accounts for travel. As such, the following discussion describes several exemplary systems and methods for predicting user travel.

Reference will now be made in detail to example embodiments of the disclosed technology that are illustrated in the accompanying drawings and disclosed herein. Wherever convenient, the same reference numbers will be used throughout the drawings to refer to the same or like parts.

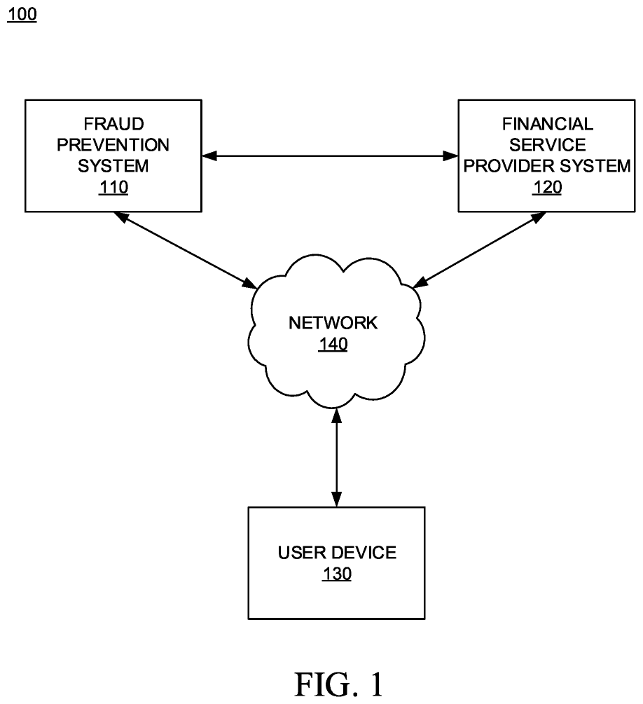

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary.

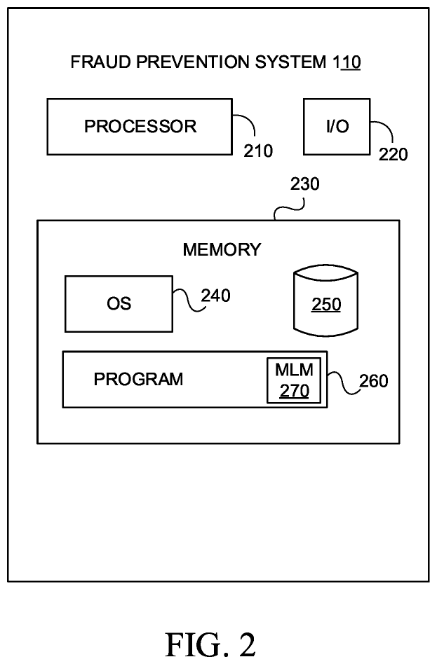

In accordance with disclosed embodiments, system 100 may include a fraud prevention system 110 (as will be discussed in more detail below with reference to FIG. 2) that may be in communication (either directly or via a network 140) with a financial service provider system 120. System 100 may also include a user device 130 that may be in communication (either directly or via network 140) with financial service provider 120 and fraud prevention system 110.

In certain embodiments, financial service provider system 120 may store and/or have access to detailed user transaction information, such as flight reservations, hotel bookings, ticket transactions, restaurant reservations, etc. Financial service provider system 120 may communicate with fraud prevention system 110 to correlate compiled data, analyze the compiled data, arrange the compiled data, generate derived data based on the compiled data, and store the compiled and derived data in a database.

User device 130 may be a mobile computing device (e.g., a smart phone, tablet computer, smart wearable device, portable laptop computer, voice command device, wearable augmented reality device, or other mobile computing device), a stationary device (e.g., desktop computer), or any other device capable of communicating with network 140 and ultimately communicating with one or more components of system 100. In some embodiments, user device 130 may include or incorporate electronic communication devices for hearing or vision impaired users. User device 130 may be operated by a user, which may include individuals such as, for example, subscribers, clients, prospective clients, or customers of an entity associated with an organization, such as individuals who have obtained, will obtain, or may obtain a product, service, or consultation from an entity associated with system 100. According to some embodiments, user device 130 may include an environmental sensor for obtaining audio or visual data, such as a microphone and/or digital camera, a geographic location sensor for determining the location of the device, an input/output device such as a transceiver for sending and receiving data, a display for displaying digital images, one or more processors including a sentiment depiction processor, and a memory in communication with the one or more processors.

Network 140 may be of any suitable type, including individual connections via the internet such as cellular or WiFi networks. In some embodiments, network 140 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

An example embodiment of fraud prevention system 110 is shown in more detail in FIG. 2. As shown, fraud prevention system 110 may include a processor 210, an input/output (“I/O”) device 220, a memory 230 containing an operating system (“OS”) 240, a database 250, and a program 260. In some embodiments, program 260 may include a machine-learning model (“MLM”) 270 that may be trained, for example, to recognize user behavior patterns (and deviations from typical patterns) based on past and/or pending credit card purchases, purchase location data, and/or other available information. In certain implementations, MLM 270 may issue commands in response to processing an event, in accordance with a model that may be continuously or intermittently updated. Moreover, processor 210 may execute one or more programs (such as via a rules-based platform or the trained MLM 270), that, when executed, perform functions related to disclosed embodiments.

Fraud prevention system 110 may be a single server or may be configured as a distributed computer system including multiple servers or computers that interoperate to perform one or more of the processes and functionalities associated with the disclosed embodiments. In some embodiments, fraud prevention system 110 may further include a peripheral interface, a transceiver, a mobile network interface in communication with processor 210, a bus configured to facilitate communication between the various components of fraud prevention system 110, and a power source configured to power one or more components of fraud prevention system 110. A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, NFC port, another like communication interface, or any combination thereof.

In some embodiments, a transceiver may be configured to communicate with compatible devices and ID tags when they are within a predetermined range. A transceiver may be compatible with one or more of: RFID, NFC, Bluetooth™, BLE, WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor 210 to communicate with other devices via wired or wireless networks, whether local or wide area, private or public, as known in the art. A power source may be configured to provide an appropriate alternating current (AC) or direct current (DC) to power components.

As described above, fraud prevention system 110 may be configured to remotely communicate with one or more other devices, such as user device 130.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files, including an operating system, application programs (including, e.g., a web browser application, a widget or gadget engine, or other applications, as necessary), executable instructions, and data. In one embodiment, the processing techniques described herein are implemented as a combination of executable instructions and data within memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Fraud prevention system 110 may include one or more storage devices configured to store information used by processor 210 (or other components) to perform certain functions related to the disclosed embodiments. In one example, fraud prevention system 110 may include memory 230 that includes instructions to enable processor 210 to execute one or more applications, such as server applications, network communication processes, and any other type of application or software known to be available on computer systems. Alternatively, the instructions, application programs, etc., may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, fraud prevention system 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, fraud prevention system 110 may include memory 230 that may include one or more programs 260 to perform one or more functions of the disclosed embodiments. Moreover, processor 210 may execute one or more programs 260 located remotely from fraud prevention system 110. For example, fraud prevention system 110 may access one or more remote programs 260, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include database 250 for storing related data to enable fraud prevention system 110 to perform one or more of the processes and functionalities associated with the disclosed embodiments.

Fraud prevention system 110 may also be communicatively connected to one or more memory devices (e.g., databases (not shown)) locally or through a network. The remote memory devices may be configured to store information and may be accessed and/or managed by fraud prevention system 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Fraud prevention system 110 may also include one or more I/O devices 220 that may include one or more interfaces for receiving signals or input from devices and providing signals or output to one or more devices that allow data to be received and/or transmitted by fraud prevention system 110. For example, fraud prevention system 110 may include interface components, which may provide interfaces to one or more input devices, such as one or more keyboards, mouse devices, touch screens, track pads, trackballs, scroll wheels, digital cameras, microphones, sensors, and the like, that enable fraud prevention system 110 to receive data from one or more users (such as via user device 130).

In example embodiments of the disclosed technology, fraud prevention system 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While fraud prevention system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations may include a greater or lesser number of components than those illustrated.

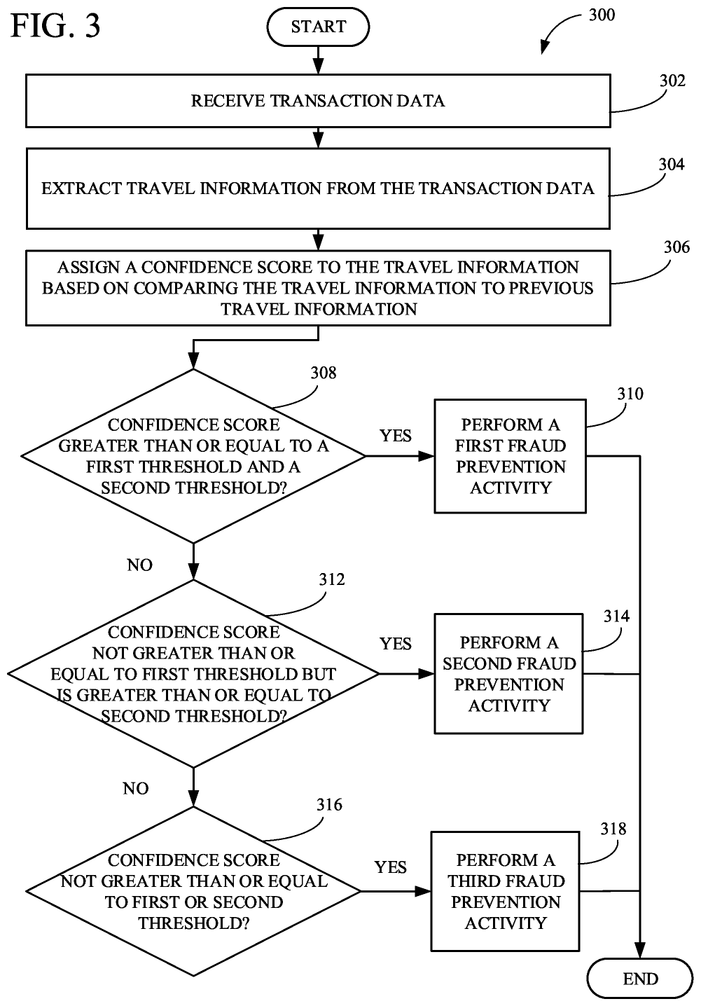

FIG. 3 shows a flowchart of a method 300 for predicting user travel. Method 300 may be performed by fraud prevention system 110, financial service provider system 120, and/or user device 130.

In block 302, the system (e.g., system 100) may receive transaction data. For example, system 100 may be affiliated with a financial institution configured to receive transaction data associated with a variety of accounts (e.g., credit, debit, etc.). System 100 may receive this transaction data by, e.g., compiling account statements associated with one or more users. The received transaction data may cover a predefined period of time, e.g., six months, one year, etc. The transaction data may include authorized and posted transaction tables, as well as information pertaining to transaction dates, transaction times, transaction amounts, merchants or other entities, locations, and the like.

In block 304, the system (e.g., system 100) may extract travel information from the transaction data. The travel information may comprise one or more types of information, such as rate information, location information, merchant information, transaction times, transaction dates, and the like. System 100 may extract the travel information by, for example, identifying each of the above described types of information, and organizing each, e.g., in a separate database, or a booking portal owned and/or operated by system 100.

In block 306, the system (e.g., system 100) may assign a confidence score to the travel information based on comparing the travel information to previous travel information. The confidence score may represent a likelihood of travel, e.g., a percent likelihood. In some embodiments, comparing the travel information to previous travel information may involve utilizing an MLM. The MLM may comprise a recurring transaction model that uses sine and cosine encodings of cyclical events to create continuous value features. This type of model may identify travel patterns of users over different time intervals (e.g., weeks, months, quarters, years, etc.) to determine the likelihood a user might travel again during an upcoming interval. This MLM model may also identify specific origins of travel, destinations of travel, merchants, and/or prices over the evaluated time intervals, such that system 100 may also recommend certain future travel activities to users, as further discussed below.

In other embodiments, the MLM may comprise a clustering algorithm to group users with similar travel histories. This MLM may utilize sparse vectors to represent purchases made or travel booked to localities outside users' home locations. The MLM may operate via an embedded neural network based either on the sparse vectors or on dense vectors resulting from translation of the sparse vectors. If using sparse vectors, the MLM may calculate cosine distances between different users' vectors to determine similarities between users' travel patterns. If using dense vectors, the MLM may sum or average users' vectors to provide representations of users' travel histories, or may take cosine or other distance calculations between vectors to identify similar travel patterns of other users. Using either of these methods, the MLM may then compare travel information of different users to not only predict future travel, but to also recommend future travel activities to users, as further discussed below. These features provide an added benefit of the system being able to perform less stringent fraud prevention activities the more confident the system is that an account is in fact being used for travel. At the same time, the less confident the system is that an account is being used for travel, the tighter of restrictions it may place on an account to prevent potentially fraudulent activity.

In block 308, the system (e.g., system 100) may determine whether the confidence score is greater than or equal to a first threshold and a second threshold. The first threshold may represent a higher or stronger likelihood of user travel than that of the second threshold. For example, the first threshold may represent a 90% likelihood of user travel, while the second threshold may represent an 80% likelihood of user travel. Selection of threshold values and/or boundaries may be based on achieving a balance between precision and recall, which may each be more or less important based on business intent. That is, for purposes of contacting customers, higher precision may be most critical, whereas higher recall may be most critical for purposes of monitoring accounts for fraudulent transactions.

In block 310, responsive to determining the confidence score is greater than or equal to the first threshold and the second threshold, the system (e.g., system 100) may perform a first fraud prevention activity. In some embodiments, the first fraud prevention activity may involve flagging an account associated with the travel information as being used for travel. Flagging the account may comprise modifying a status indicator of the account for display in an associated user's account or profile, transmitting a message to a user device associated with the account (e.g., user device 130) indicating the account has been flagged for travel, prompting the associated user via the user device to confirm flagging the account for travel, and the like. These features provide an added benefit of account protection and usability in that the system provides for automatic monitoring of accounts when the system is more certain that those accounts will be used for travel. These features further eliminate the need for account users to proactively contact financial institutions to alert them to upcoming travel.

In other embodiments, the first fraud prevention activity may involve identifying one or more activities compatible with the travel information, and providing one or more recommendations corresponding to the one or more activities to a user associated with the account. Identifying the one or more activities may comprise identifying one or more events associated with a date, a time, and/or a location of the travel information. The one or more recommendations may comprise one or more of a flight, a hotel reservation, a restaurant reservation, a recreational activity, a conference, and/or the like. Providing the one or more recommendations may be based on a variety of factors, for example, price, exact location, merchant reviews, etc. System 100 may be configured to provide the one or more recommendations to the user in a variety of ways, such as via email (e.g., provided by the user in an online account profile), SMS messaging (e.g., if the user has previously opted into receiving SMS messaging via a mobile number), in-application messaging, push notifications, downloadable lists, etc.

For example, system 100 may have (in block 304) extracted an upcoming hotel room reservation of a user in a certain location and over a certain date range. Responsive to determining the user's likelihood of travel is greater than both the first and second thresholds (e.g., 80% or higher, as in the above example), system 100 may identify several compatible flights, i.e., flight reservations that would enable the user to get to the correct location on the correct date to align with the already booked hotel reservation. System 100 may then select two of the identified compatible flights to provide as recommendations to the user based on, for example, price and whether the flights are direct (non-stop) flights. System 100 may also provide additional recommendations out of a variety of other identified compatible activities, for example, a restaurant reservation for the first evening the user arrives in the travel location, the restaurant reservation recommendation being based on online customer reviews. System 100 may identify the one or more compatible activities and provide the one or more recommendations to the user by using one of the above outlined MLMs, by using a web crawler to pull in information from external websites (e.g., Expedia, TripAdvisor, Google, etc.), by using an Application Programming Interface (API) and/or other integrations with external websites, or by using a booking portal owned and/or operated by system 100. These features provide an added benefit of travel organization and ease in that users do not have to rely solely on manual reservation searching and coordination to put together a full itinerary.

In block 312, the system (e.g., system 100) may determine whether the confidence score is not greater than or equal to the first threshold but is greater than or equal to the second threshold.

In block 314, responsive to determining the confidence score is not greater than or equal to the first threshold but is greater than or equal to the second threshold, the system (e.g., system 100) may perform a second fraud prevention activity. In some embodiments, the second fraud prevention activity may comprise reducing a credit limit of an account associated with the travel information. By how much a credit limit is reduced may be based on, e.g., a default setting of system 100, or a user preference pre-selected by a user associated with the account.

In block 316, the system (e.g., system 100) may determine whether the confidence score is not greater than or equal to the first threshold or the second threshold.

In block 318, responsive to determining the confidence score is not greater than or equal to the first threshold or the second threshold, the system (e.g., system 100) may perform a third fraud prevention activity. In some embodiments, the third fraud prevention activity may comprise locking an account associated with the travel information. In other embodiments, the third fraud prevention activity may further comprise transmitting a message to a user of the account to identify whether the account is being used for travel. That is, either immediately prior to or following the locking of the account, system 100 may transmit a message (e.g., an email, SMS message, in-application message, push-notification, etc.) to a user device associated with the account (e.g., user device 130) to have the user confirm the account is being used for, or will be used for, travel purposes. Based on the user's response to this message, system 100 may be configured to either prevent locking of the account (if the account has not yet been locked), or conduct automatic unlocking of the account (if the account has already been locked). These features provide an added benefit of allowing the user to step in to prevent the locking of an account, or the system to automatically re-open an account, in the event the system was incorrect in determining the account was not being used for travel.

With any of the above described fraud prevention activities, system 100 may be configured to provide to an account user, e.g., via a graphical user interface (GUI) of an associated user device, a form of input such as a drop-down selector, a text box for entry of a free-form response, one or more direct link options, and the like. Such an input may enable users to efficiently notify system 100 if a travel prediction was incorrectly made. Based on this notification, system 100 may then be configured to take further action in monitoring of the respective account. This feature provides an added benefit of a final check to ensure user accounts are being accurately monitored for fraudulent activity.

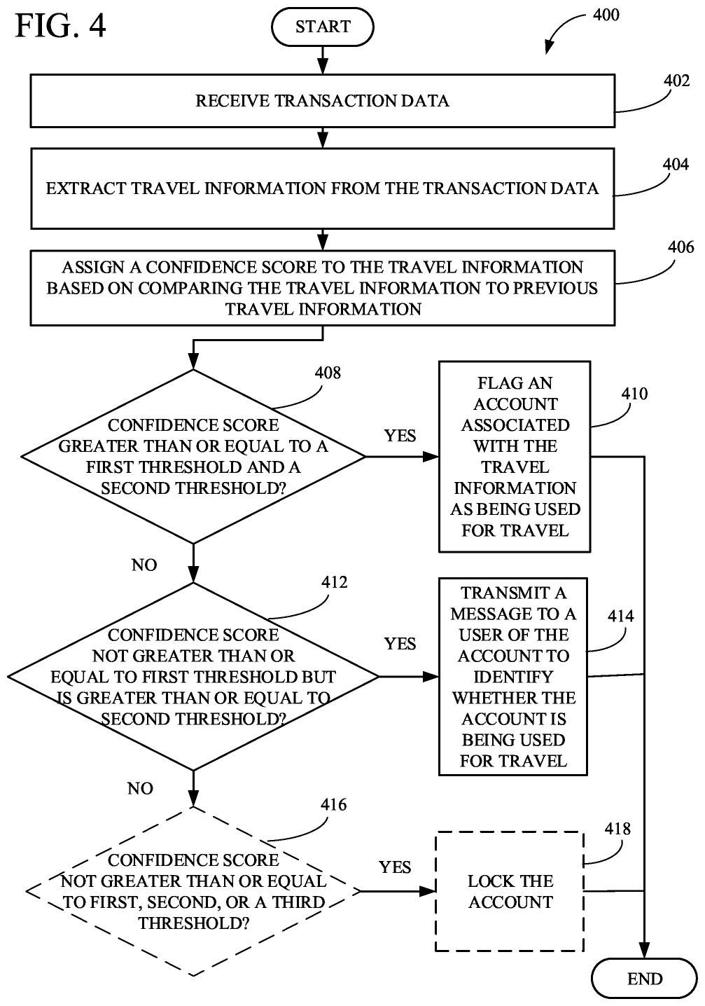

FIG. 4 shows a flowchart of a method 400 for predicting user travel. Method 400 may also be performed by fraud prevention system 110, financial service provider system 120, and/or user device 130. Method 400 is similar to method 300 of FIG. 3. The descriptions of blocks 402, 404, 406, 408, 410, 412, 414, 416, and 418 of method 400 are the same as or similar to the respective descriptions of blocks 302, 304, 306, 308, 310, 312, 314, 316, and 318 of method 300, and as such, are not repeated herein for brevity.

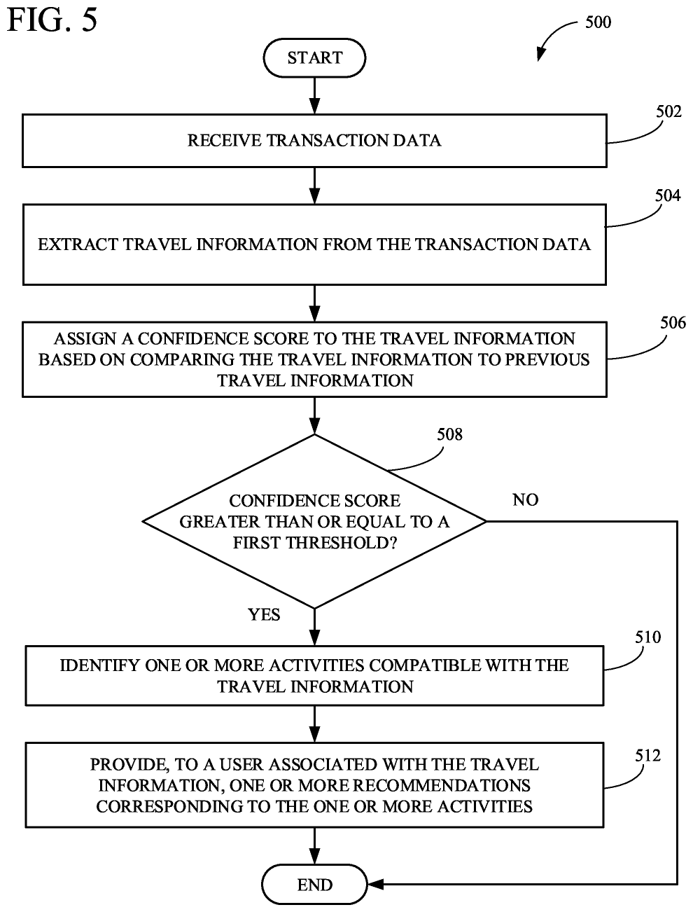

FIG. 5 shows a flowchart of a method 500 for predicting user travel. Method 500 may also be performed by fraud prevention system 110, financial service provider system 120, and/or user device 130. Method 500 is similar to method 300 of FIG. 3 except that method 500 does not include blocks similar to blocks 312, 314, 316, or 318. The description of blocks 502, 504, 506, 508, 510, and 512 of method 500 are the same as or similar to the respective descriptions of blocks 302, 304, 306, 308, and 310 (combines blocks 510 and 512) of method 300, and as such, are not repeated herein for brevity.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices that may include mobile computing devices. Those skilled in the art will recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Example Use Cases

The following example use cases describe examples of a typical user flow pattern. They are intended solely for explanatory purposes and not in limitation.

In one example, a system may be associated with a financial institution, and may be configured to receive transaction data associated with a plurality of users. This transaction data may indicate times, dates, locations, merchants, etc., associated with each transaction conducted by each user over a six-month period. The system may extract travel information, for example, a restaurant reservation of a first user, from the transaction data. The system may be able to extract the name and location of the restaurant, and the date of the reservation. Using an MLM, the system may then assign a confidence score, e.g., 78%, to the restaurant reservation by comparing it to other previous restaurant reservations made by the first user as well as other users of the plurality of users with similar travel histories as the first user. The system may then determine whether the assigned confidence score is greater than or equal to one or more pre-selected thresholds that indicate the first user's likelihood of travel. A first threshold may represent an 85% likelihood of user travel, and a second threshold may represent a 70% likelihood of user travel. The system may determine that the confidence score of 78% is not greater than or equal to the first threshold, but is greater than or equal to the second threshold. Based on that determination, the system may automatically reduce the allowable credit limit on an account of the first user, the account being the account used for making the restaurant reservation. The reduction in the allowable credit limit may be based on a default setting within the system. The system may then transmit a message to the first user via a display on the first user's mobile device, wherein the message includes a direct link labeled “please respond if this credit reduction was made in error.” The system may then recognize the first user's selection of the link and may automatically revert the credit limit on the account to the original credit limit.

In another example, the system may be similar to the system in the above example but may instead extract a ticket reservation for seeing an exhibit at The Metropolitan Museum of Art in New York City on Oct. 7, 2021. Using an MLM, the system may then assign a confidence score, e.g., 94%, to the ticket reservation by comparing it to other previous recreational activity reservations made by the first user as well as other users of the plurality of users with similar travel histories as the first user. The system may then determine whether the assigned confidence score is greater than or equal to a first threshold, which may represent a 90% likelihood of user travel. Based on determining the confidence score of 94% is greater than or equal to the first threshold, the system may identify five different flight reservation options that would get the first user to New York City on Oct. 6, 2021, as well as five different hotel reservation options for the nights of Oct. 6-7, 2021 in New York City. The system may then send an email to the first user recommending three of the five flight options and three of the five hotel options. The system may recommend three out of the five flight options based on price and layover length, and three out of the five hotel options based on price and distance from the museum.

What is claimed is:

1. A system for predicting user travel, comprising:
one or more processors; and
a memory in communication with the one or more processors and storing instructions that, when executed by the one or more processors, are configured to cause the system to:
receive transaction data;
extract travel information from the transaction data;
assign a confidence score to the travel information based on comparing the travel information to previous travel information;
determine whether the confidence score is greater than or equal to a first threshold;
determine whether the confidence score is greater than or equal to a second threshold;
responsive to determining the confidence score is greater than or equal to the first threshold and the second threshold, perform a first fraud prevention activity;
responsive to determining the confidence score is not greater than or equal to the first threshold but is greater than or equal to the second threshold, perform a second fraud prevention activity; and
responsive to determining the confidence score is not greater than or equal to the first threshold or the second threshold, perform a third fraud prevention activity.

2. The system of claim 1, wherein the first fraud prevention activity comprises flagging an account associated with the travel information as being used for travel.

3. The system of claim 2, wherein the first fraud prevention activity further comprises:
identify one or more activities compatible with the travel information; and
providing, to a user associated with the account, one or more recommendations corresponding to the one or more activities.

4. The system of claim 3, wherein identifying the one or more activities comprises identifying one or more events associated with a date, a time, and a location of the travel information.

5. The system of claim 4, wherein the one or more recommendations may comprise one or more of a flight, a hotel reservation, a restaurant reservation, a recreational activity, a conference, or combinations thereof.

6. The system of claim 1, wherein the second fraud prevention activity comprises reducing a credit limit of an account associated with the travel information.

7. The system of claim 1, wherein the third fraud prevention activity comprises locking an account associated with the travel information.

8. The system of claim 7, wherein the third fraud prevention activity further comprises transmitting a message to a user of the account to identify whether the account is being used for travel.

9. The system of claim 1, wherein assigning a confidence score comprises utilizing a machine-learning model.

10. The system of claim 1, wherein the travel information comprises one or more of location information, merchant information, entity information, time information, date information, price information, or combinations thereof.

11. A system for predicting user travel, comprising:
one or more processors; and
a memory in communication with the one or more processors and storing instructions that, when executed by the one or more processors, are configured to cause the system to:
receive transaction data;
extract travel information from the transaction data;
assign a confidence score to the travel information based on comparing the travel information to previous travel information;
determine whether the confidence score is greater than or equal to a first threshold;
determine whether the confidence score is greater than or equal to a second threshold;
responsive to determining the confidence score is greater than or equal to the first threshold and the second threshold, flag an account associated with the travel information as being used for travel; and
responsive to determining the confidence score is not greater than or equal to the first threshold but is greater than or equal to the second threshold, transmit a message to a user of the account to identify whether the account is being used for travel.

12. The system of claim 11, wherein the instructions are further configured to cause the system to:
determine whether the confidence score is greater than or equal to a third threshold; and
responsive to determining the confidence score is not greater than or equal to the first threshold or the second threshold but is greater than or equal to the third threshold, reduce a credit limit of the account.

13. The system of claim 12, wherein the instructions are further configured to cause the system to:
responsive to determining the confidence score is not greater than or equal to the first threshold, the second threshold, or the third threshold, lock the account.

14. The system of claim 11, wherein responsive to determining the confidence score is greater than or equal to the first threshold and the second threshold, the instructions are further configured to cause the system to:
identify one or more activities compatible with the travel information; and
provide, to the user, one or more recommendations corresponding to the one or more activities.

15. The system of claim 14, wherein identifying the one or more activities comprises identifying one or more events associated with a date, a time, and a location of the travel information.

16. The system of claim 15, wherein the one or more recommendations may comprise one or more of a flight, a hotel reservation, a restaurant reservation, a recreational activity, a conference, or combinations thereof.

17. A system for predicting user travel, comprising:
one or more processors; and
a memory in communication with the one or more processors and storing instructions that, when executed by the one or more processors, are configured to cause the system to:
receive transaction data;
extract travel information from the transaction data;
assign a confidence score to the travel information based on comparing the travel information to previous travel information;
determine whether the confidence score is greater than or equal to a first threshold;
responsive to determining the confidence score is greater than or equal to the first threshold:
identify one or more activities compatible with the travel information; and
provide, to a user associated with the travel information, one or more recommendations corresponding to the one or more activities.

18. The system of claim 17, wherein the travel information comprises one or more of location information, merchant information, time information, date information, price information, or combinations thereof.

19. The system of claim 17, wherein assigning a confidence score comprises utilizing a machine-learning model.

20. The system of claim 17, wherein identifying the one or more activities comprises identifying one or more events associated with a date, a time, and a location of the travel information, and wherein the one or more recommendations comprising one or more of a flight, a hotel reservation, a restaurant reservation, a recreational activity, a conference, or combinations thereof.
